(19) United States
(12) Patent Application Publication
(10) Pub. No.: US 2024/0183494 A1
(43) Pub. Date: Jun. 6, 2024

(54) MULTILAYER STRUCTURE FOR TRANSPORTING OR STORING HYDROGEN

(71) Applicant: ARKEMA FRANCE, COLOMBES (FR)

(72) Inventors: Thibaut SAVART, Lacq (FR); Arthur BABEAU, Lacq (FR); Axel SALINIER, Lacq (FR); Gilles HOCHSTETTER, Colombes (FR); Alexandre HAUCK, Maslacq (FR); Damien BUSCA, Port-de-Lanne (FR)

(73) Assignee: ARKEMA FRANCE, COLOMBES (FR)

(21) Appl. No.: 18/285,830

(22) PCT Filed: Mar. 31, 2022
(86) PCT No.: PCT/FR2022/050605

§ 371 Date: Oct. 5, 2023

(30) Foreign Application Priority Data
Apr. 7, 2021 (FR) FR2103534

(51) Int. Cl. F17C 1/06; F16L 9/04; F16L 9/12

(52) U.S. Cl. CPC F17C 1/06; F16L 9/04; F16L 9/12; F17C 2201/0104; F17C 2201/0147; F17C 2203/012; F17C 2203/0621; F17C 2203/0624; F17C 2203/066; F17C 2203/0673; F17C 2209/2163; F17C 2209/232; F17C 2221/012

(57) ABSTRACT

A multilayer structure, intended for the transportation, for the distribution or for the storage of a gas, in particular hydrogen, including, from the inside toward the outside, N composite reinforcing layer(s), deposited on one another, and being of a fibrous material in the form of continuous fibers which is impregnated by a composition of at least one semicrystalline thermoplastic polymer P1, the M.p. of which, as measured according to ISO 11357-3:2013, is greater than or equal to 150° C., or at least one amorphous thermoplastic polymer, the Tg of which is greater than 80° C., N being of from 1 to 2000 layers, and an outer sealing layer (1) cohesive with the outermost composite reinforcing layer (2) and including a composition of the at least one thermoplastic polymer P1, the composition of the outer sealing layer (1) resulting from at least the outermost composite reinforcing layer (2) cohesive with the sealing layer.

### TECHNICAL FIELD

The present invention relates to composite multilayer structures for the transportation, distribution or storage of gases, in particular hydrogen, and to their process of manufacture.

### PRIOR ART

At present, gas storage tanks, in particular hydrogen storage tanks and more particularly cryogenic tanks, must meet the following constraints:
low permeability to the stored gas;
high thermo-mechanical strength, whatever the environmental conditions and the phases of use of the tank (filling, emptying, in use, on store, and the like);
resistance of the sealing layers (liner and/or composite) to low temperatures in the case of storage at very low temperature or cryostorage;
no or few releases of polluting compounds into the stored gas.

Cryogenic tanks generally have a double wall, into which the vacuum is created, which gives them very good thermal insulation. In this case, the inner wall is often made of aluminum in order to maintain very good impermeability and not to degrade the vacuum by diffusion of the gas into the double wall.

In the case of a cryo-compressed tank, the inner wall can be made of composite, in order to withstand the pressure, and this composite can be coated with a layer of aluminum in order to ensure perfect gastightness, in particular to hydrogen. The manufacture of this layer by coating an aluminum film onto a tank made of composite (thermoplastic (TP) or thermosetting (TS)) is very difficult to carry out because of the low adhesion of aluminum to a structure weakly loaded with resin because heavily loaded with fiber in order to be mechanically resistant, in particular, in the context of the manufacture of tanks under high pressures (300, 350, 700 bar). In addition, the manufacture of tanks by putting down TP tapes, which are heavily loaded with fibers, is difficult because the high fiber content can impair the adhesion of the tapes to one another.

Moreover, the “organic” liners generally used for conventional gas storage at reasonable temperatures are of polyethylene or polypropylene type because they are of low cost and easy to process while having a relatively low permeability to gases. However, they also exhibit the following disadvantages:
low mechanical strength,
all the lower at low temperature,
increase in the permeability to gases at high temperature,
release of monomers or other polluting compounds into the gas during the filling/decompression phases of the tank.

In addition, these liners release, during the filling/emptying (compression/decompression) phases, molecules/particles, such as residual oligomers, plasticizers, and the like, which pollute the stored gas and end up by being re-encountered in the fuel cell and contaminating it and/or degrading it. The tests put in place to monitor the quality of the stored gas and its change following these cycles are generally a critical stage in the certification of storage tanks.

These tanks currently on the market or under development are thus of type IV, with a liner and a mechanically resistant structure having little physico-chemical compatibility and thus little cohesion with each other. To be mechanically resistant to pressurization/decompression cycles, liners are generally thick (to prevent them from collapsing on themselves during the decompression phases) and thus heavy, unnecessarily adding weight to the tank.

In addition, tanks including metal are themselves very heavy.

It is thus necessary to overcome the abovementioned disadvantages.

The present invention thus relates to a multilayer structure, intended for the transportation, for the distribution or for the storage of a gas, in particular hydrogen, comprising, from the inside toward the outside,
N composite reinforcing layer(s), deposited on one another, and consisting of a fibrous material in the form of continuous fibers impregnated by a composition comprising predominantly at least one semicrystalline thermoplastic polymer P1, the M.p. of which, as measured according to ISO 11357-3:2013, is greater than or equal to 150° C., or at least one amorphous thermoplastic polymer, the Tg of which is greater than 80° C.,
N being of from 1 to 2000 layers, preferentially from 2 to 1000, more preferably from 2 to 500, and
an outer sealing layer (1) cohesive with the outermost composite reinforcing layer (2) and consisting of said composition comprising predominantly said at least one thermoplastic polymer P1, polypropylene being excluded from said semicrystalline thermoplastic polymer P1,
said composition of the outer sealing layer (1) resulting from at least the outermost composite reinforcing layer (2), said outer sealing layer (1) exhibiting a thickness of at least 5 μm, in particular of at least 10 μm, the sum of the thicknesses of each composite reinforcing layer (2) and of the thickness of the sealing layer being equal to the sum of the thicknesses of said N layers before deposition, minus possible porosities.

The inventors have thus found, unexpectedly, that a multilayer structure consisting of a layer rich in thermoplastic polymer (P1) on the outer part of the tank, cohesive with the outermost composite reinforcing layer (2), and which results from at least the outermost composite reinforcing layer (2) cohesive with the sealing layer (1), made possible the transportation, the distribution or the storage of a gas, in particular hydrogen, and, because of the presence of said layer rich in thermoplastic polymer (P1), exhibited a very good barrier to gas, in particular to hydrogen, without necessarily having to use a liner made of thermoplastic polymer as inner sealing layer, while reinforcing the mechanical strength performance qualities of the composite reinforcing layer (2) by virtue of the elimination of the residual porosities, when present, of said composite reinforcing layers, thus resulting in good mechanical strength performance qualities.

The expression “very good barrier to gas” means that the layer rich in thermoplastic polymer (P1) is a barrier layer to the gas, in particular to hydrogen, and that it thus exhibits characteristics of low permeability and of good resistance to gases, in particular to hydrogen, that is to say that said barrier layer slows down the passage of the gas, in particular hydrogen, to the outside of said multilayer structure. The barrier layer is thus a layer making it possible above all not to lose too much gas, in particular to the atmosphere by diffusion, thus making it possible to minimize the cost associated with the losses of stored gas, to minimize the risks of ignition or of explosion when hydrogen is involved.

The term “multilayer structure” should be understood as meaning a tank comprising or consisting of at least two layers, in particular of several layers, namely at least one composite reinforcing layer (2) and an outer sealing layer (1) cohesive with the outer composite reinforcing layer (2).

The tank can be a tank for the mobile storage of gas, in particular hydrogen, that is to say on a truck for transporting gas, in particular hydrogen, on a car for transporting gas, in particular hydrogen and especially the feeding with hydrogen of a fuel cell for example, on a train for feeding with hydrogen or on a drone for feeding with hydrogen, but it can also be a stationary storage tank for gas, in particular hydrogen, a site for the distribution of gas, in particular hydrogen, to vehicles.

The multilayer structure in the present invention also denotes a pipe or a tube intended for the transportation of gas, in particular hydrogen, from the tank to the fuel cell and which comprises or consists of several layers, namely an outer sealing layer (1) and at least one outermost composite reinforcing layer (2), cohesive with the sealing layer (1).

The term “gas” denotes a constituent chosen from air, oxygen (O₂), nitrogen (N₂), carbon dioxide (CO₂), carbon monoxide (CO), argon (Ar), helium (He), methane (CH₄), ethylene (C₂H₄), propane (C₃H₈), butane (C₄H₁₀), liquefied natural gas (LNG), liquefied petroleum gas (LPG) or hydrogen (H₂), especially hydrogen.

The term “cohesive” means that the outermost composite reinforcing layer (2) is integrally attached to the outer sealing layer (1), in other words that they are adherent and inseparable from one another.

The expression “a composition comprising predominantly said at least one thermoplastic polymer P1” means that said thermoplastic polymer P1 is present in a proportion of more than 50% by weight, with respect to the total weight of said composition.

The expression “said composition of the outer sealing layer (1) resulting from at least the outermost composite reinforcing layer (2)” means that said composition originates solely from the migration of the composition which impregnates at least the outermost composite reinforcing layer (2) during the manufacture of said multilayer structure and that it does not result, for example, from the extrusion of an outer sealing layer (1) comprising the thermoplastic polymer P1 over the outermost composite reinforcing layer (2).

If the multilayer structure comprises several composite reinforcing layers, said composition of the outer sealing layer (1) results or originates from the last composite reinforcing layer or from various composite reinforcing layers.

The sum of the thicknesses of each composite reinforcing layer (2) and of the thickness of the sealing layer is equal to the sum of the thicknesses of said N layers before deposition if said layers before deposition do not exhibit porosities and if the deposition of these N layers does not generate porosities between or within layers. The porosities represent the void between the fibers by volume.

The expression “minus possible porosities” thus means that, if said N layers before deposition exhibit a porosity of x %, then the sum of the thicknesses of each composite reinforcing layer (2) and of the thickness of the sealing layer is equal to the sum of the thicknesses of said N layers—x % of said sum, if the variation in the width of the tape during its deposition remains negligible.

As regards the composition impregnating the fibrous material

The composition comprises predominantly a thermoplastic polymer P1, that is to say that the thermoplastic polymer P1 is present in a proportion of more than 50% by weight, with respect to the total weight of said composition.

Advantageously, the thermoplastic polymer P1 is present in a proportion of more than 60% by weight, with respect to the total weight of said composition.

Advantageously, the thermoplastic polymer P1 is present in a proportion of more than 70% by weight, with respect to the total weight of said composition.

Advantageously, the thermoplastic polymer P1 is present in a proportion of more than 80% by weight, with respect to the total weight of said composition.

Optionally, the thermoplastic polymer or blend of thermoplastic polymers additionally comprises carbon-based fillers, in particular carbon black or carbon-based nanofillers, preferably chosen from carbon-based nanofillers, in particular graphenes and/or carbon nanotubes and/or carbon nanofibrils or their mixtures. These fillers make it possible to conduct electricity and heat, and consequently make it possible to facilitate the melting of the polymer matrix when it is heated.

Optionally, said composition comprises at least one additive, in particular chosen from a catalyst, an antioxidant, a heat stabilizer, a UV stabilizer, a light stabilizer, a lubricant, a filler, a plasticizer, a flame retardant, a nucleating agent, a dye, an electrically conductive agent, a thermally conductive agent or a mixture of these.

Advantageously, said additive is chosen from a flame retardant, an electrically conductive agent and a thermally conductive agent.

The additive can be present at up to 5% by weight, with respect to the total weight of the composition.

Optionally, said composition comprises at least one impact modifier.

The impact modifier can be any impact modifier provided that it is a polymer with a lower modulus than that of the resin, exhibiting good adhesion with the matrix, so as to dissipate the cracking energy.

The impact modifier advantageously consists of a polymer exhibiting a flexural modulus of less than 100 MPa, measured according to the standard ISO 178, and with a Tg of less than 0° C. (measured according to the standard ISO 11357-2 at the inflection point of the DSC thermogram), in particular a polyolefin.

In one embodiment, PEBAs are excluded from the definition of the impact modifiers.

The polyolefin of the impact modifier can be functionalized or nonfunctionalized or be a mixture of at least one which is functionalized and/or of at least one which is nonfunctionalized.

The impact modifier can be present at up to 30% of the total weight of the composition.

According to another alternative form, the thermoplastic polymer or blend of thermoplastic polymers can additionally comprise liquid crystal polymers or cyclic poly(butylene terephthalate), or mixtures containing them, as additive. These compounds make it possible in particular to fluidize the polymer matrix in the molten state, for better penetration to the core of the fibers. Depending on the nature of the thermoplastic polymer or blend of thermoplastic polymers used to produce the impregnation matrix, in particular its melting point, one or other of these compounds will be chosen.

In a first embodiment, said composition comprises, by weight:
at least 65% of thermoplastic polymer P1, in particular at least 80% of thermoplastic polymer P1, especially at least 83% of thermoplastic polymer P1,
up to 30% of impact modifier, in particular from 0% to less than 15% of impact modifier, especially from 0% to 12% of impact modifier,
up to 5% of additives,
the sum of the constituents by weight of the composition being equal to 100%.

Advantageously, said composition consists, by weight, of:
at least 65% of thermoplastic polymer P1, in particular at least 80% of thermoplastic polymer P1, especially at least 83% of thermoplastic polymer P1,
up to 30% of impact modifier, in particular up to less than 15% of impact modifier, especially up to 12% of impact modifier,
up to 5% of additives,
the sum of the constituents by weight of the composition being equal to 100%.

In a second embodiment, said composition comprises, by weight:
at least 65% of thermoplastic polymer P1, in particular at least 80% of thermoplastic polymer P1, especially at least 83% of thermoplastic polymer P1,
from 0.1% to 30% of impact modifier, in particular from 0.1% to less than 15% of impact modifier, especially from 0.1% to 12% of impact modifier,
up to 5% of additives,
the sum of the constituents by weight of the composition being equal to 100%.

Advantageously, said composition consists, by weight, of:
at least 65% of thermoplastic polymer P1, in particular at least 80% of thermoplastic polymer P1, especially at least 83% of thermoplastic polymer P1,
from 0.1% to 30% of impact modifier, in particular from 0.1% to less than 15% of impact modifier, especially from 0.1% to 12% of impact modifier,
up to 5% of additives,
the sum of the constituents by weight of the composition being equal to 100%.

In a third embodiment, said composition comprises, by weight:
at least 65% of thermoplastic polymer P1, in particular at least 80% of thermoplastic polymer P1, especially at least 83% of thermoplastic polymer P1,
up to 30% of impact modifier, in particular from 0% to less than 15% of impact modifier, especially from 0% to 12% of impact modifier,
from 0.1% to 5% of additives,
the sum of the constituents by weight of the composition being equal to 100%.

Advantageously, said composition consists, by weight, of:
at least 65% of thermoplastic polymer P1, in particular at least 80% of thermoplastic polymer P1, especially at least 83% of thermoplastic polymer P1,
up to 30% of impact modifier, in particular up to less than 15% of impact modifier, especially up to 12% of impact modifier,
from 0.1% to 5% of additives,
the sum of the constituents by weight of the composition being equal to 100%.

In a fourth embodiment, said composition comprises, by weight:
at least 65% of thermoplastic polymer P1, in particular at least 80% of thermoplastic polymer P1, especially at least 83% of thermoplastic polymer P1,
from 0.1% to 30% of impact modifier, in particular from 0.1% to less than 15% of impact modifier, especially from 0.1% to 12% of impact modifier,
from 0.1% to 5% of additives,
the sum of the constituents by weight of the composition being equal to 100%.

Advantageously, said composition consists, by weight, of:
at least 65% of thermoplastic polymer P1, in particular at least 80% of thermoplastic polymer P1, especially at least 83% of thermoplastic polymer P1,
from 0.1% to 30% of impact modifier, in particular from 0.1% to less than 15% of impact modifier, especially from 0.1% to 12% of impact modifier,
from 0.1% to 5% of additives,
the sum of the constituents by weight of the composition being equal to 100%.

### As Regards the Thermoplastic Polymer P1

The thermoplastic polymer can be a reactive thermoplastic prepolymer or a nonreactive thermoplastic polymer, with the exclusion of polypropylene.

The expression “nonreactive thermoplastic polymer” means that the molecular weight is no longer likely to change significantly, that is to say that its number-average molecular weight (Mn) changes by less than 25% during its processing and thus corresponds to the final polymer of the thermoplastic matrix.

The expression “reactive thermoplastic prepolymer or reactive thermoplastic polymer” means that the molecular weight is likely to change significantly, that is to say that its number-average molecular weight (Mn) changes by more than 25% during its processing and thus does not correspond to the final polymer of the thermoplastic matrix.

The Mn is determined in particular by the calculation, starting from the content of terminal functions determined by potentiometric titration in solution, of the functionality of said prepolymers or by NMR assay (Postma et al. (Polymer, 47, 1899-1911 (2006))).

The number-average molecular weight Mn of a nonreactive polymer is greater than or equal to 11 000 g/mol.

The number-average molecular weight Mn of a reactive prepolymer is of from 500 g/mol to less than 11 000 g/mol, in particular from 500 to 10 000 g/mol, more particularly of from 1000 to 9000, in particular from 1500 to 7000, more particularly still from 2000 to 5000 g/mol.

The number-average molecular weight Mn of said final polymer of the thermoplastic matrix is preferably within a range extending from 11 000 g/mol to 40 000 g/mol, preferably from 12 000 g/mol to 30 000 g/mol. These Mn values can correspond to inherent viscosities of greater than or equal to 0.8, as determined in m-cresol according to the standard ISO 307:2007 but while changing the solvent (use of m-cresol in place of sulfuric acid and the temperature being 20° C.).

The Mn values are determined in particular by the calculation, starting from the content of the terminal functions determined by potentiometric titration in solution.

The Mn weights can also be determined by size exclusion chromatography or by NMR.

Advantageously, the melt viscosity of said thermoplastic polymer P1 is less than or equal to 500 Pa·s, especially less than or equal to 200 Pa·s, in particular less than or equal to 100 Pa·s, as measured by plane-plane rheology at 1 Hz and 2% deformation, at the deposition temperature of the fibrous material.

The term “thermoplastic” or “thermoplastic prepolymer” or “thermoplastic polymer” is understood to mean a material which is generally solid at ambient temperature, which can be semicrystalline or amorphous, and which softens during an increase in temperature, in particular after passing its glass transition temperature (Tg) and flows at higher temperature when it is amorphous, or which can exhibit sharp melting on passing its “melting” point (M.p.) when it is semicrystalline, and which becomes solid again during a reduction in temperature below its crystallization temperature (for a semicrystalline material) and below its glass transition temperature (for an amorphous material).

The Tg and the M.p. are determined by differential scanning calorimetry (DSC) according to the standards ISO 11357-2:2013 and 11357-3:2013 respectively.

The thermoplastic polymer can be an amorphous polymer exhibiting a glass transition temperature Tg of greater than or equal to 80° C., in particular of greater than or equal to 100° C., especially of greater than or equal to 120° C., in particular of greater than or equal to 140° C., or a semicrystalline thermoplastic polymer, the melting point M.p. of which is greater than 150° C.

Advantageously, said at least one thermoplastic polymer is selected from: poly(aryl ether ketone)s (PAEKs), in particular poly(ether ether ketone) (PEEK); poly(aryl ether ketone ketone)s (PAEKKs), in particular poly(ether ketone ketone) (PEKK); aromatic polyetherimides (PEIs); polyaryl sulfones, in particular polyphenylene sulfones (PPSUs); polyaryl sulfides, in particular polyphenylene sulfides (PPSs); polyamides (PAs), in particular semiaromatic polyamides (polyphthalamides) optionally modified by urea units; PEBAs, the M.p. of which is greater than 150° C.; polyacrylates, in particular polymethyl methacrylate (PMMA); polyolefins, with the exclusion of polypropylene; polylactic acid (PLA); polyvinyl alcohol (PVA); fluoropolymers, in particular polyvinylidene fluoride (PVDF) or polytetrafluoroethylene (PTFE) or polychlorotrifluoroethylene (PCTFE); and their mixtures, in particular a mixture of PEKK and of PEI, preferably from 90-10% by weight to 60-40% by weight, in particular from 90-10% by weight to 70-30% by weight.

Advantageously, said at least one thermoplastic polymer is selected from polyamides, aliphatic polyamides, cycloaliphatic polyamides and semiaromatic polyamides (polyphthalamides), PEKK, PEI and a mixture of PEKK and of PEI.

The nomenclature used to define the polyamides is described in the standard ISO 1874-1:2011, “Plastics-Polyamide (PA) Moulding and Extrusion Materials—Part 1: Designation”, in particular on page 3 (tables 1 and 2), and is well known to a person skilled in the art.

The polyamide can be a homopolyamide or a copolyamide or a blend thereof.

For structural parts which have to withstand high temperatures, besides the fluoropolymers, use is advantageously made according to the invention of poly(aryl ether ketone)s PAEKs, such as poly(ether ketone)s PEKs, poly(ether ether ketone) PEEK, poly(ether ketone ketone) PEKK, poly(ether ketone ether ketone ketone) (PEKEKK) or PAs having a high glass transition temperature Tg.

Advantageously, said polyamide is chosen from aliphatic polyamides, cycloaliphatic polyamides and semiaromatic polyamides (polyphthalamides).

Advantageously, said aliphatic polyamide prepolymer is chosen from:
polyamide 6 (PA6), polyamide 11 (PA11), polyamide 12 (PA12), polyamide 66 (PA66), polyamide 46 (PA46), polyamide 610 (PA610), polyamide 612 (PA612), polyamide 1010 (PA1010), polyamide 1012 (PA1012), polyamide 11/1010 (PA11/1010) and polyamide 12/1010 (PA12/1010), or a blend of these or a copolyamide of these, and block copolymers, in particular polyamide/polyether (PEBA), and said semiaromatic polyamide is a semiaromatic polyamide, optionally modified by urea units, in particular a PA MXD6 and a PA MXD10, or a semiaromatic polyamide of formula X/YAr, as are described in EP 1 505 099, in particular a semiaromatic polyamide of formula A/XT in which A is chosen from a unit obtained from an amino acid, a unit obtained from a lactam and a unit corresponding to the formula (Ca diamine).(Cb diacid), with a representing the number of carbon atoms of the diamine and b representing the number of carbon atoms of the diacid, a and b each being of between 4 and 36, advantageously between 9 and 18, the (Ca diamine) unit being chosen from linear or branched aliphatic diamines, cycloaliphatic diamines and alkylaromatic diamines and the (Cb diacid) unit being chosen from linear or branched aliphatic diacids, cycloaliphatic diacids and aromatic diacids;

XT denotes a unit obtained from the polycondensation of a Cx diamine and terephthalic acid, with x representing the number of carbon atoms of the Cx diamine, x being of between 6 and 36, advantageously between 9 and 18, in particular a polyamide of formula A/6T, A/9T, A/10T or A/11T, A being as defined above, in particular a polyamide PA 6/6T, a PA 66/6T, a PA 61/6T, a PA MPMDT/6T, a PA 11/10T, a PA 11/6T/10T, a PA MXDT/10T, a PA MPMDT/10T, a PA BACT/10T, a PA BACT/6T, a PA BACT/10T/6T or a PA 11/BACT/10T.

T corresponds to terephthalic acid, MXD corresponds to m-xylylenediamine, MPMD corresponds to methylpentamethylenediamine and BAC corresponds to bis(aminomethyl)cyclohexane.

Advantageously, said polymer is a semicrystalline polymer.

Advantageously, said semicrystalline polymer exhibits a glass transition temperature such that Tg≥80° C., in particular Tg≥100° C., especially≥120° C., in particular≥140° C., and an M.p.≥150° C.

In the latter case, said at least one semicrystalline thermoplastic polymer is selected from: poly(aryl ether ketone)s (PAEKs), in particular poly(ether ether ketone) (PEEK); poly(aryl ether ketone ketone)s (PAEKKs), in particular poly(ether ketone ketone) (PEKK); aromatic polyetherimides (PEIs); polyaryl sulfones, in particular polyphenylene sulfones (PPSUs); polyaryl sulfides, in particular polyphenylene sulfides (PPSs); polyamides (PAS), in particular semiaromatic polyamides (polyphthalamides) optionally modified by urea units; polyacrylates, in particular polymethyl methacrylate (PMMA); polyolefins, with the exclusion of polypropylene; polylactic acid (PLA); polyvinyl alcohol (PVA); and their mixtures, in particular a mixture of PEKK and of PEI, preferably from 90-10% by weight to 60-40% by weight, in particular from 90-10% by weight to 70-30% by weight.

More advantageously, in the latter case, said at least one thermoplastic polymer is selected from polyamides, aliphatic polyamides, cycloaliphatic polyamides and semiaromatic polyamides (polyphthalamides), PEKK, PEI and a mixture of PEKK and of PEI.

### As Regards the Fibrous Material

Throughout the description, the term strip or band or bands of fibrous material impregnated with a thermoplastic polymer or tape can be used and denotes the same thing.

Concerning the constituent fibers of said fibrous material, these are in particular fibers of inorganic, organic or vegetable origin in the form of rovings.

Advantageously, the number of fibers per roving is, for carbon fibers, greater than or equal to 24 K, in particular greater than or equal to 50 K, especially of from 24 to 35 K.

Advantageously, the number of fibers per roving is, for carbon fibers, greater than or equal to 30 K, especially is greater than or equal to 50 K.

Advantageously, the basis weight for the glass fiber is greater than or equal to 1200 tex, in particular less than or equal to 4800 tex, especially of from 1200 to 2400 tex.

Mention may be made, among the fibers of inorganic origin, of carbon fibers, glass fibers, basalt or basalt-based fibers, silica fibers or silicon carbide fibers, for example. Mention may be made, among the fibers of organic origin, of fibers based on thermoplastic or thermosetting polymer, such as semiaromatic polyamide fibers, aramid fibers or polyolefin fibers, for example. Preferably, they are based on amorphous thermoplastic polymer and exhibit a glass transition temperature Tg which is greater than the Tg of the constituent thermoplastic polymer or polymer blend of the impregnation matrix when the polymer or polymer blend is amorphous or greater than the M.p. of the constituent thermoplastic polymer or polymer blend of the impregnation matrix when the polymer or polymer blend is semicrystalline. Advantageously, they are based on semicrystalline thermoplastic polymer and exhibit a melting point M.p. which is greater than the Tg of the constituent thermoplastic polymer or polymer blend of the impregnation matrix when the polymer or polymer blend is amorphous or greater than the M.p. of the constituent thermoplastic polymer or polymer blend of the impregnation matrix when the polymer or polymer blend is semicrystalline. Thus, there is no risk of melting for the constituent organic fibers of the fibrous material during the impregnation by the thermoplastic matrix of the final composite. Mention may be made, among the fibers of vegetable origin, of natural fibers based on flax, hemp, lignin, bamboo, silk, in particular spider silk, sisal, and other cellulose fibers, in particular viscose fibers. These fibers of vegetable origin can be used pure, treated or else coated with a coating layer, for the purpose of facilitating the adhesion and impregnation of the thermoplastic polymer matrix.

It can also correspond to fibers with support yarns.

These constituent fibers can be used alone or as mixtures. Thus, organic fibers can be mixed with inorganic fibers in order to be impregnated with thermoplastic polymer and to form the impregnated fibrous material.

The rovings of organic fibers can have several basis weights. In addition, they can exhibit several geometries.

The fibers are provided in the form of continuous fibers, which make up 2D fabrics, nonwovens (NCF), braids or rovings of unidirectional (UD) fibers or nonwovens. The constituent fibers of the fibrous material can additionally be in the form of a mixture of these reinforcing fibers of various geometries.

Preferably, the fibrous material is chosen from glass fibers, carbon fibers, basalt fibers and basalt-based fibers.

Advantageously, it is used in the form of a roving or of several rovings.

In the impregnated materials, also referred to as “ready for use” materials, the impregnating thermoplastic polymer or polymer blend is distributed uniformly and homogeneously around the fibers. In this type of material, the impregnating thermoplastic polymer must be distributed as homogeneously as possible within the fibers in order to obtain a minimum of porosities, that is to say a minimum of voids between the fibers. Specifically, the presence of porosities in materials of this type can act as points of concentrations of stresses, for example during placing under mechanical tensile stress, and which then form points of initiation of failure of the impregnated fibrous material and mechanically weaken it. A homogeneous distribution of the polymer or polymer blend thus improves the mechanical strength and the homogeneity of the composite material formed from these impregnated fibrous materials.

Advantageously, the content of fibers in said impregnated fibrous material is of from 45% to 65% by volume, preferably from 50% to 60% by volume, in particular from 54% to 60% by volume.

The measurement of the degree of impregnation can be carried out by image analysis (use of microscope or of camera or of digital camera, in particular) of a cross section of the strip, by dividing the surface area of the strip impregnated by the polymer by the total surface area of the product (impregnated surface area plus surface area of the porosities). In order to obtain a good quality image, it is preferable to coat the strip, cut across its transverse direction, in a standard polishing resin and to polish with a standard protocol making possible the observation of the sample with a microscope at at least six times magnification.

Advantageously, the degree of porosity of said impregnated fibrous material is less than 10%, in particular less than 5%, especially less than 2%.

It should be noted that a degree of porosity of zero is difficult to achieve and that consequently, advantageously, the degree of porosity is greater than 0% but less than the abovementioned degrees.

The degree of porosity corresponds to the degree of closed porosity and can be determined either by electron microscopy, or as being the relative deviation between the theoretical density and the experimental density of said impregnated fibrous material as described in the examples part of the present invention.

As Regards the Multilayer Structure

Said multilayer structure defined above comprises, from the inside to the outside:
N composite reinforcing layer(s), deposited one on top of the other,
N being of from 1 to 2000 layers, preferentially from 2 to 1000, more preferentially from 2 to 500, and an outer sealing layer (1) cohesive with the outermost composite reinforcing layer (2).

Said structure thus comprises at least one composite reinforcing layer (2) and an outer sealing layer (1).

Advantageously, it comprises at least two composite reinforcing layers.

When the multilayer structure is a cylindrical tank or a tube or pipe, the first composite reinforcing layer (2) which constitutes said tank or tube or pipe can be positioned in the longitudinal axis of said structure, perpendicular to the longitudinal axis of said structure, or with an angle of more than 0° to less than 90° with respect to the longitudinal axis of said structure.

Whatever the orientation of the first composite reinforcing layer (2), it must in any case cover the entire surface of the structure. Said composite reinforcing layer (2) N can then be formed from the placing together of several bands of fibrous material side by side or with a slight overlap.

Each composite reinforcing layer (2) N is subsequently deposited on the layer N−1 in an orientation which is identical to the orientation of the layer N−1 or in an orientation perpendicular to that of the layer N−1 or else with an angle of from more than 0° to less than 90° with respect to the orientation of the layer N−1.

Whatever the number of reinforcing layers, said outer sealing layer (1) results from at least the outermost composite reinforcing layer (2) and it exhibits a thickness of at least 5 μm, in particular of at least 10 μm.

The sum of the thicknesses of each composite reinforcing layer (2) and of the thickness of the outer sealing layer (1) is equal to the sum of the thicknesses of said N layers before deposition, minus possible porosities, which means that said composition originates solely from the migration of the composition which impregnates at least the outermost composite reinforcing layer (2) during the manufacture of said multilayer structure and that it does not result, for example, from the extrusion of an outer sealing layer (1) comprising the thermoplastic polymer P1 over the outermost composite reinforcing layer (2).

When several reinforcing layers are present, said outer sealing layer (1) thus results from the last layer or from all the reinforcing layers present in said structure, without this being obligatory. This is because the composition impregnating the fibrous material of each composite reinforcing layer (2) migrates partially outwards when the layer N is applied to the layer N−1, which has the consequence of depleting each composite reinforcing layer (2) in composition comprising the thermoplastic polymer P1 and of enriching it in fiber. The composition which has migrated thus constitutes the outer sealing layer which exhibits excellent barrier properties to the gas contained in the multilayer structure.

There is thus preservation of the material over all of the reinforcing layers and of the outer sealing layer thus created and consequently the sum of the thicknesses of each composite reinforcing layer (2) and the thickness of the outer sealing layer (1) is equal to the sum of the thicknesses of said N layers before deposition, minus any porosities.

The advantage of this type of multilayer structure exhibiting said outer sealing layer (1) is that the stages of painting or finishing, indeed even of coating with an additional outer impermeability layer, which is optionally metallic and/or heat-insulating, are facilitated by the presence of an outer thermoplastic polymer layer which is thus malleable and which makes possible welding with an additional layer.

It can also make it possible to lay down an additional layer of aluminum, for example in order to reinforce the tank and/or to render it even more impermeable to gas and/or to heat.

This polymer layer can also be considered as a finishing element of the tank and/or a paint support.

The N reinforcing layers constituting said structure can comprise the same composition comprising the thermoplastic polymer P1 or can comprise different compositions comprising the thermoplastic polymer P1. In the latter case, each polymer P1 of each composite reinforcing layer (2) is partially or completely miscible with each polymer P1 of the adjacent layer(s).

Also, in the latter case, the sealing layer will then be a mixture of the different compositions comprising the thermoplastic polymer P1 and thus said sealing layer will comprise a blend of thermoplastic polymer P1.

Advantageously, the N reinforcing layers constituting said structure comprise the same composition comprising the thermoplastic polymer P1.

In one embodiment, each composite reinforcing layer (2) consists, before deposition, of said fibrous material in the form of impregnated continuous fibers exhibiting an initial content of fibers of from 45% to 65% by volume.

In another embodiment, each composite reinforcing layer (2) consists, after deposition, of said fibrous material in the form of impregnated continuous fibers exhibiting a content of fibers of from 50% to 70% by volume, in particular from 60% to 70% by volume.

In another embodiment, each composite reinforcing layer (2) consists, before deposition, of said fibrous material in the form of impregnated continuous fibers exhibiting an initial content of fibers of from 45% to 65% by volume and each composite reinforcing layer (2) consists, after deposition, of said fibrous material in the form of impregnated continuous fibers exhibiting a content of fibers of from 50% to 70% by volume, in particular from 60% to 70% by volume.

As indicated above, during the deposition, there is migration of the composition constituting said fibrous material outwards, which has the consequence of enriching the impregnated fibrous material in fibers.

In one embodiment, all the reinforcing layers exhibit substantially the same content of fibers after deposition, except for the last layer, which is enriched in fibers due to the migration of the resin to form the outer polymer layer.

In another embodiment, the reinforcing layers exhibit a gradient of content of fibers by volume after deposition, said gradient being decreasing but of from 50% to 70% by volume, in particular from 60% to 70% by volume.

In this case, the innermost composite reinforcing layer (2) thus exhibits the highest content of fibers by volume and the outermost composite reinforcing layer (2) exhibits the lowest content of fibers by volume.

In another embodiment, the reinforcing layers exhibit a gradient in content of fibers by volume after deposition, said gradient being increasing but of from 50% to 70% by volume, in particular from 60% to 70% by volume.

In this case, the innermost composite reinforcing layer (2) thus exhibits the lowest content of fibers by volume and the outermost composite reinforcing layer (2) exhibits the highest content of fibers by volume.

Advantageously, the residual porosities, when they are present, of said composite reinforcing layers are decreased by at most 90%.

This decrease in the residual porosities makes it possible to reinforce the mechanical strength performance qualities of said composite reinforcing layers (2).

In yet another embodiment, the total thickness, corresponding to the sum of the thicknesses of each composite reinforcing layer (2) after deposition and of the thickness of the outer sealing layer, is equal to N×the initial thickness (Thᵢ) of each composite reinforcing layer (2) before deposition, minus possible porosities.

The consequence of this is that the thickness of the sealing layer is of from:

5 μm to [(1−(T_{min before deposition}/T_{max after deposition}))×N×Thᵢ×(1−x %)]μm [Math 1]

in which:
T represents the content of fibers by volume,
T_{min before deposition} represents the minimum content of fibers by volume before deposition, that is to say that of the tape before deposition,
T_{max after deposition} represents the maximum content of fibers by volume in the reinforcing layer after deposition,
N represents the number of reinforcing layers,
Thᵢ represents the initial thickness of the impregnated fibrous material before deposition,
x % represents the percentage of porosities in the tape before deposition,
this equation being valid if the variations in width of the tape before and after deposition are considered to be negligible.

In one embodiment, the thickness of the sealing layer is of from:

10 μm to [(1−(T_{min before deposition}/T_{max after deposition}))×N×Thᵢ×(1−x %)]μm [Math 2]

In a first alternative form, said multilayer structure defined above is devoid of an inner sealing layer (3) located under the innermost composite reinforcing layer (2), said innermost composite reinforcing layer (2) being in contact with the gas.

Since the inner sealing layer (3) does not exist, there thus exists no internal liner in this first alternative form.

The gas of said multilayer structure is thus in contact with the composite material enriched in fibers and depleted in composition comprising the thermoplastic polymer P1, compared with the initial material consisting of fibers and of the composition comprising the thermoplastic polymer P1 which has impregnated the fibrous material.

A tank having good mechanical performance qualities is thus obtained.

In addition, the in situ formation of the outer sealing layer (1) makes it possible to potentially eliminate the inner sealing layer (3) (liner), without this being obligatory, which lightens the tank.

The elimination of the inner sealing layer (3) (liner) offers the advantage of eliminating the risk of collapse of the liner during the compression/decompression phases, when this liner is not adherent to the composite, as is the case with type IV tanks.

Similarly, the gas stored in contact with a layer enriched in fibers and thus depleted in polymer will be less polluted by the constituents of said polymer of said reinforcing layer in contact with the gas.

It is also possible to vary the state of compaction of the mechanical reinforcing layers of the tank and thus to vary the thickness of the impermeable polymer barrier at the surface of the tank, by suitably adapting the conditions of deposition of the bands of fibrous material constituting the layer N.

This means that, starting from any band of fibrous material (i.e. whatever its content of fibers, its initial thickness, and the like) impregnated with at least one thermoplastic resin, it is possible to manufacture a multilayer structure as defined above.

These considerations are particularly true for polymers which are fluid (not very viscous) at the targeted conversion temperatures because they are capable of flowing through the layers of tapes already deposited under favorable productivity conditions.

Moreover, in one embodiment, the production time of the tanks is improved because the liner (sealing layer) is not manufactured, either inside or outside during secondary operations.

This is because the outer sealing layer (1) is obtained as the composite reinforcing layers are manufactured, which may suffice for the sealing of the tank and which greatly increases the productivity of the process. In addition, the productivity is all the more increased and the initial capital cost of the process for the manufacture of the tanks reduced as the manufacture of the sealing layer generally requires the use of separate items of equipment from the composite material.

In a second alternative form, said multilayer structure defined above furthermore comprises at least one inner sealing layer (3), located under the innermost composite reinforcing layer (2) and consisting of a composition comprising predominantly at least one semicrystalline thermoplastic polymer P2, the M.p. of which, measured according to ISO 11357-3:2013, is less than 300° C., in particular less than 265° C., said innermost inner sealing layer (3) being in contact with the gas.

In this second alternative form, said structure thus comprises an inner liner in contact with the gas.

Advantageously, a thermosetting polymer is excluded from the constituent composition of the inner sealing layer (3).

It may be necessary to further increase the barrier properties of the multilayer structure with respect to gas, in particular hydrogen, and it is then necessary to have at least one inner sealing layer (3), located under the innermost composite reinforcing layer (2), the innermost inner sealing layer (3) then being in contact with the gas.

This structure, while having good mechanical performance qualities as above, also exhibits excellent barrier properties to gas, in particular to hydrogen.

The composition comprising predominantly at least one thermoplastic polymer P2 is as described for the composition comprising the thermoplastic polymer P1, with the exception of polypropylene, which is excluded from said semicrystalline thermoplastic polymer P2.

The composition comprising predominantly at least one thermoplastic polymer P2 can be the same as that comprising the thermoplastic polymer P1 in said structure or it can be different.

Advantageously, said innermost composite reinforcing layer (2) is welded to said adjacent outermost inner sealing layer (3).

Advantageously, the polymer P2 of each sealing layer is partially or completely miscible with each polymer P2 of the adjacent layer(s), each polymer P1 of each composite reinforcing layer (2) is partially or completely miscible with each polymer P1 of the adjacent layer(s), and the polymer P2 of the outermost sealing layer is partially or completely miscible with the polymer P1 which is adjacent to it of the innermost composite reinforcing layer (2).

The complete or partial miscibility of said polymers is defined by the difference in glass transition temperature of the two resins in the mixture, with respect to the difference in glass transition temperature of the two resins, before mixing, and the miscibility being complete when said difference is equal to 0 and the miscibility being partial when said difference is other than 0, an immiscibility of the polymer P2 with the polymer P1 being excluded.

When the miscibility of said polymers is partial, said miscibility is all the greater the smaller said difference.

Advantageously, when the miscibility of said polymers is partial, said difference is less than 30%, preferentially less than 20%, in absolute value.

In one embodiment, the glass transition temperature(s) of the mixture, depending on whether the miscibility is complete or partial, which temperature(s) must be between the glass transition temperatures of said polymers before mixing and different from them, by at least 5° C., preferably by at least 10° C.

The expression “completely miscible” means that when, for example, two polymers P1 and P2 respectively exhibiting a Tg1 and a Tg2 are present respectively in two adjacent sealing layers or two adjacent reinforcing layers, then the blend of the two polymers exhibits only a single Tg12, the value of which is of between Tg1 and Tg2.

This value Tg12 is then greater than Tg1 by at least 5° C., in particular by at least 10° C., and less than Tg2 by at least 5° C., in particular by at least 10° C.

The expression “partially miscible” means that when, for example, two polymers P1 and P2 respectively exhibiting a Tg1 and a Tg2 are present respectively in two adjacent sealing layers or two adjacent reinforcing layers, then the blend of the two polymers exhibits two Tg values: Tg′1 and Tg12, with Tg1<Tg′1<Tg12<Tg2.

These values Tg′1 and Tg′2 are then greater than Tg1 by at least 5° C., in particular by at least 10° C., and less than Tg2 by at least 5° C., in particular by at least 10° C.

An immiscibility of two polymers is reflected by the presence of two Tg values, Tg1 and Tg2, in the blend of the two polymers which correspond to the respective Tg values Tg1 and Tg2 of the pure polymers taken separately.

In a third alternative form, said multilayer structure defined above furthermore comprises at least one inner sealing layer (3), made of composite material, located under the composite reinforcing layer (2) and consisting of fibers impregnated with a composition comprising predominantly at least one semicrystalline thermoplastic polymer P2, the M.p. of which, measured according to ISO 11357-3:2013, is less than 300° C., in particular less than 265° C., said innermost inner sealing layer (3) being in contact with the gas.

In one embodiment of either of the first and second alternative forms defined above, said gas is hydrogen and the total proportion of extracted contaminants in the hydrogen is less than or equal to 3% by weight, in particular less than 2% by weight, of the sum of the constituents of said composition impregnating said fibrous material or of the composition constituting said inner sealing layer (3), as determined by a test of contaminants present in the hydrogen and extracted from said composite reinforcing layer (2) or from said inner sealing layer (3) after contact of the hydrogen with this, said test being carried out as defined in the standard CSA/ANSI CHMC 2:19.

The test of contaminants present in the hydrogen and extracted from said composite reinforcing layer (2) or from said inner sealing layer (3) after contact of the hydrogen with this determines that the proportion of contaminants present in the hydrogen and resulting from said composite reinforcing layer (2) or from said inner sealing layer (3) after contact with the hydrogen, whether it concerns a tank or a pipe, does not exceed the limiting values preventing the proper operation of the fuel cell.

The standard CSA/ANSI CHMC 2:19 provides details on the procedure used to determine the volatile components in the headspace of a polymer during exposure to hydrogen during service.

The expression “after contact of the hydrogen with this” means, just as above, exposure to hydrogen during service.

### Apparatus

The test equipment must comprise the following elements:
(a) a cryofocus to preconcentrate the gas samples;
(b) a gas chromatograph using an appropriate column, connected in series with an appropriate selective mass detector;
(c) headspace vials (40 ml), septa, ring closures and vial sealant;
(d) an analytical balance which can weigh up to 60.0001 g; and
e) a convection oven capable of maintaining a temperature of 70±5° C.

### Test Environment

### Purity of the Hydrogen Gas

The conditioning hydrogen gas must be of known composition and of known purity, as described below.

The purity of the hydrogen gas used to fill the test cell must be, at a minimum, in accordance with the standard ISO 14687:2019, Parts 1 to 3, or SAE J2719 (2015). ISO 14687-2 defines the most stringent hydrogen quality specification, with the lowest threshold values for each impurity among these ISO standards (see Table 1). SAE J2719 also applies to proton exchange membrane (PEM) fuel cell vehicles and is harmonized with ISO 14687-2.

TABLE 1

| Characteristics | | Limit |
|---|---|---|
| Combustible index | Minimum molar fraction | 99.97% |
| Total nonhydrogen gas | — | 300 |
| Maximum concentration of | | |
| the individual contaminants | | |
| Water | H₂O | 5 |
| Total hydrocarbon | Base CH₄ | 2 |
| Methane | CH₄ | 100 |
| Oxygen | O₂ | 5 |
| Helium | He | 300 |
| Total nitrogen and argon | N₂, Ar | 300 |
| Carbon dioxide | CO₂ | 2 |
| Total monoxide, | Σ CO + CH₂O + CH₂O₂ | 0.2 |
| formaldehyde and formic | | |
| acid | | |
| Carbon monoxide | CO | 0.2 |
| Formaldehyde | CH₂O | 0.2 |
| Formic acid | CH₂O₂ | 0.2 |
| Total sulfur-based | Base H₂S | 0.004 |
| compounds | | |
| Ammonia | NH₃ | 0.1 |
| Total halogenated | — | 0.05 |
| compounds | | |
| Maximum concentration of | — | 1 mg/kg |
| (liquid and solid) particles | | |

* all the values are given in ppm (v/v) unless otherwise specified
† when the values given in this table 1 differ from the current edition of the standard ISO 14687-2: 2019, the current values apply.

### Measurement and Instrumentation

The temperature at which the measurements of the rate of hydrogen transmission are carried out must be controlled to within ±1° C. The test pressure must remain constant to within 1% of the test value.

### Test Procedure

The test procedure is described in the standard ISO 14687:2019 in the section 5.6.

In one embodiment, the multilayer structure as defined above is chosen from a cylindrical tank, a polymorphic tank (i.e. a tank consisting of a small-diameter tube assembly), a bendable pipe (i.e. a pipe which can be bent after having been preheated) and a bent pipe (i.e. a pipe which exhibits curves).

In one embodiment, said multilayer structure defined above exhibits a resistance to decompression and an aptitude for drying (i.e. by virtue of the fact that said structure is composed of a sealed composite reinforcement without liner or comprises a welded liner cohesive with the reinforcement).

In yet another embodiment, said multilayer structure defined above furthermore exhibits at least one outer layer (4), in particular chosen from a polymer layer or a metal layer, especially a metal layer, in particular an aluminum layer, said outer layer (4) being the outermost layer of said multilayer structure.

The outer layer (4) can thus be a polymer, in particular made of thermoplastic polymer, especially made of polyamide.

It can also be metallic, in particular made of aluminum.

According to another aspect, the present invention relates to a process for the manufacture of a multilayer structure as defined above, characterized in that it comprises a stage of deposition of at least one band of fibrous material impregnated with a thermoplastic polymer on a support, in order to form a composite reinforcing layer N, by means of a main heating system chosen from:
a system (1) for preheating said impregnated band of fibrous material before deposition of said band on said support, and a system for heating said impregnated band of fibrous material on its inner face (2) at the point of contact of said band with said support,
in combination with at least one secondary heating system making it possible for the composite reinforcing layer (2) N−1 on which the layer N will be deposited to be at a temperature greater than the M.p. of said thermoplastic polymer at the moment of contact of said layer N with said layer N−1.

The bands can be deposited according to one of the processes of the prior art well known to a person skilled in the art, such as automated tape laying (ATL) technologies. This family of process systems is broken down into several technologies, such as automated fiber placement (AFP), tape winding (for the manufacture of parts having rotational geometry), and the like. Robots will unwind and place preimpregnated bands in very specific locations by means of a robotic system. This system is generally broken down into a multiaxial robotic arm at the end of which is attached a deposition head within which the preimpregnated bands progress forward. The head serves to guide these bands but also to cut them at the moment of the change in trajectory of the robot during the manufacture of the part. It also generally comprises a gripping roller making it possible to apply pressure to the band during its deposition. Finally, it is equipped with one or more heating means making it possible to heat the impregnated band in order to melt the polymer which it contains and thus making it possible to cause it to adhere to the band or the support on which it is deposited.

Several heating means can be used on this deposition head: laser, light-emitting diode or LED, ultraviolet (UV), hot air source, infrared (IR), and the like. They heat the sheet being deposited and sometimes they also slightly heat the support on which the bands are deposited in order to facilitate the adhesion and to improve the quality of the composite deposited.

The deposition can in particular be carried out with a deposition head and/or a guide.

The term “support” denotes any base on which the bands n are successively deposited. When a first band is deposited on said support, the support is bare, that is to say devoid of any material other than the constituent material of said support. After deposition of a first band, the latter can completely cover the entire surface of the support.

In this case, the following band n deposited by the process of the invention covers the previously deposited band n−1, and so on.

It can also only partially cover the surface of the support. In this case, the following band n deposited by the process of the invention does not cover the preceding band n−1 but is deposited on the support and overlaps or does not overlap or adjoins the band n−1 previously deposited on the support.

In the case where the following band n deposited by the process of the invention overlaps or adjoins the band n−1 deposited beforehand on the support, this is how it is until the entire support is covered with a single band thickness.

In the case where the following band n deposited by the process of the invention does not overlap and does not adjoin the band n−1 deposited beforehand on the support, this is how it is as far as the other end of the support and consequently several bands over a single band thickness partially cover the support. The following bands will be deposited on the first band series (the several bands over a single band thickness), either in the same way or in “crossed” fashion above the first series.

The deposition of bands forming beforehand a fabric of intertwined or interlaced bands is excluded from the invention.

As a general rule, the support is cylindrical in shape.

When it is cylindrical in shape, the support can be fixed or rotary, in particular fixed.

If it is rotary, the axis of rotation is not in the plane of the support and the head for deposition of the band, which makes it possible to bring the band and the support into contact, is driven with a translational movement in the plane of the support.

Examples of systems for heating (5) on a rotary cylindrical support, without being limited to them, are presented in FIGS. 1 and 2.

The term “cylindrical shape” should be understood as meaning a cylinder which is a regular surface, the generatrices of which are parallel, that is to say a surface in the space consisting of parallel straight lines.

When it is cylindrical, the support can be simultaneously in rotation and in translation along the axis of the cylinder, while the head for deposition of the band, which makes it possible to bring the band and the support into contact, is fixed.

Alternatively, when the support is cylindrical, the support can be in rotation along the axis of the cylinder, while the head for deposition of the band, which makes it possible to bring the band and the support into contact, is driven with a translational movement parallel to the axis of the tube.

The support can be made of any substance provided that it withstands the heat of the various heating means and the heat of the band itself, as well as the pressure strains exerted during the deposition of the bands.

The support can be a thermoplastic material or a metal material or a ceramic material or a combination of these materials, provided that it meets said abovementioned conditions.

The support can in particular be said inner sealing layer (1) (liner) prepared according to methods well known to a person skilled in the art, especially by rotational molding.

In one embodiment, the secondary heating is chosen from the following:
a system for heating said impregnated band of fibrous material on its outer face (3) at the point of contact of said band with said support,
a system (4) for postheating said impregnated band n of fibrous material after deposition of said band n on said support,
a system (5) for heating said support, and
a system (6) for preheating the impregnated band n−1 of fibrous material previously deposited before deposition of said band n of fibrous material,
it being possible for said systems 4 and 6 to be combined.

An example of combined infrared heating systems (6) and (4) in the presence of a cylindrical support in rotation and in translation along the axis of the heating or nonheating cylinder (5), without being limited to this, is presented in FIG. 1.

Advantageously, said at least one main and secondary heating system is chosen from a heat-transfer fluid, induction heating, direct current, a heating cartridge, a heating press roller, a light-emitting diode (LED), infrared (IR), a UV source, hot air and a laser, it being possible for said primary and secondary heating systems to be identical or different.

In one embodiment, said process furthermore comprises a stage of deposition of at least one outer layer (4), which is in particular metallic, especially made of aluminum, said layer being the outermost layer of said multilayer structure.

In a first alternative form, said outer layer (4) comprises or consists of a composition comprising a polymer and is deposited by a system for extrusion/coating, for example with polymer film, or by a technique similar to that presented in the context of this invention for the reinforcing layers, namely unwinding of polymer film, heating of this film and winding around the reinforcing structure created.

In a second alternative form, said outer layer (4) is metallic and is deposited by coating with a sheet of metal, the assembling with the tank being carried out by bonding or heating of the reinforcement and of the metal layer in order to weld them together.

### DESCRIPTION OF THE FIGURES

FIG. 1 exhibits the various possible heating systems (2), (3), (4) and (6) on a cylindrical support seen in cross section exhibiting an optional heating system (5).

FIG. 2 exhibits the various possible combined heating systems (4) and (6) on a cylindrical and rotary support optionally exhibiting a heating system (5).

FIG. 3 exhibits the various systems for heating by laser (2) and heating press roller (3) on a rotary cylindrical support exhibiting a heating system (5) (heating mandrel).

FIG. 4 exhibits the micrograph of a tank of the invention obtained with bands of example 1 comprising a sealing layer (1) and composite reinforcing layers (2).

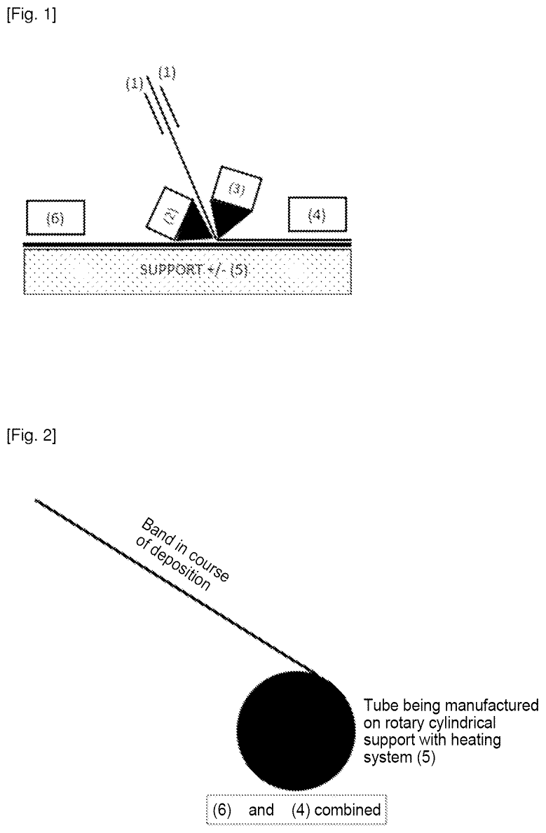

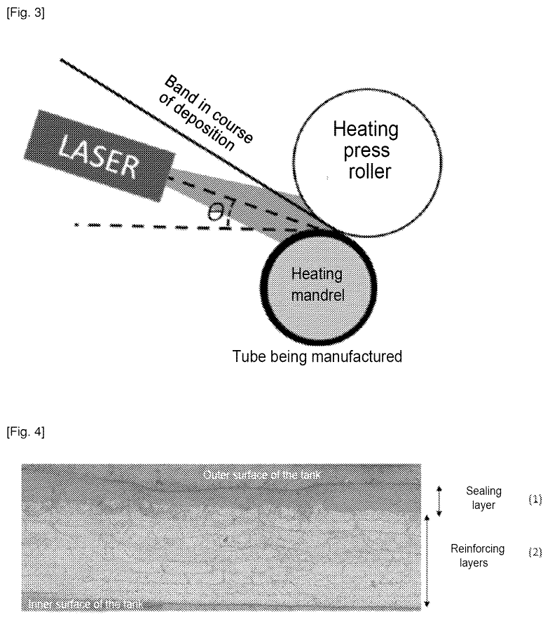

### EXAMPLES

### Example 1: Preparation of Bands of Fibrous Material

The bands of fibrous material were prepared according to WO2018/234436: example 2 (band of fibrous material (carbon fiber, SGL, 24K, reference C T24-5.0 270-T140), monolayer impregnated with PA11) and example 5 for the degree of porosity. A mean thickness of these tapes at 250 μm and a degree of porosity of approximately 3% are measured.

The content of fibers by volume of the band of impregnated fibrous material obtained is 45% vCF, its melting point is 190° C., its M.p._{endset} is 200° C. and its Tg is at 50° C. The Tc of this polymer is equal to 150° C.

### Example 2: Preparation of a Tank of the Invention with the Bands of Fibrous Material of Example 1

The bands of prepregs obtained are placed on a creel making it possible to manage the mechanical tension of unwinding these reels of prepregs. An unwinding tension is set at 50N for each of the 3 bands which are unwound in parallel.

These 3 bands progress forward at a speed of 30 m/min under infrared (IR) radiating devices with a total length of 150 cm and with a maximum power of 50 kW. The power of these infrared devices is regulated and self-regulated via a temperature measurement on the prepreg bands (by virtue of an IR pyrometer placed at halfway under the IR devices and a control thermal camera at the heating medium outlet) in order to ensure that, at the outlet of this heating medium, the bands are at a temperature above the melting point. In this example, a temperature of 230° C. exists at the hottest point.

The bands are then guided via ceramic guides to prevent them from deviating from their deposition path.

They are then deposited on the cylindrical metal winding support, with a diameter of 300 mm, which is itself placed on a 6-axis robot. The bands progress forward and are pulled up to the deposition support by virtue of the rotational force of the metal mandrel which constitutes the winding support.

At the moment of the deposition of the layer N, the reinforcing layer N-1 already deposited is brought to a temperature greater than M.p. (in this instance 210° C.) by virtue of IR emitters placed circumferentially around the cylinder acting as deposition support and being integrally attached to the structure of the robotic arm. These IR emitters have a maximum power of 25 kW each and are 3 in number, for a length of emitters of 120 cm each. They are placed beside one another so as to heat only the layer N−1 over its working zone before deposition of the layer N. In order to limit heat losses and thus promote the migration of the resin during the deposition toward the outer layer, a heating mandrel maintained at 160° C. throughout the test is used.

The creation of a dense layer of PA11 at the outer surface of this tank section with a thickness of 450 μm is observed. This dense layer, free from carbon fiber, results from the migration/wringing/flowing of molten PA11 under the effect of the pressure and of the temperature of deposition of the three tapes deposited in parallel during the manufacture of the tank which comprises, in the context of this example, 8 superimposed layers of reinforcements.

It is subsequently measured, by image analysis, that the content of fibers in the dense homolytic layers of the mechanically strong part of the tank has changed from 45% vCF (initial tape) to 58.5% vCF in the monolithic part created from the internal part of the tank up to the polymer-rich layer.

### Example 3: Determination of the Degree of Porosity by the Relative Deviation Between Theoretical Density and Experimental Density (General Method)

a) The Data Required are:
The density of the thermoplastic matrix
The density of the fibers
The basis weight of the reinforcement:
   linear density (g/m), for example for a 1/4 inch tape (resulting from a single roving)
   surface density (g/m2), for example for a wider tape or a woven fabric

b) Measurements to be Carried Out:

The number of samples must be at least 30 in order for the result to be representative of the material studied.

The measurements to be carried out are:
The size of the samples withdrawn:
   Length (if linear density known),
   Length and width (if surface density known).
The experimental density of the samples withdrawn:
   Measurements of weight in air and in water.
The measurement of the content of fibers is determined according to ISO 1172:1999 or by thermogravimetric analysis (TGA) as determined, for example, in the document B. Benzler, Applikationslabor, Mettler Toledo, Giesen, UserCom 1/2001.

The measurement of the content of carbon fibers can be determined according to ISO 14127:2008.

Determination of the Theoretical Content of Fibers by Eeight:

a) Determination of the Theoretical Content of Fibers by Weight:

$$\% {Wft}_{h} = \frac{{d}_{l} . L}{{Ws}_{air}} \qquad [ Math 3 ]$$

with
d1 the linear density of the tape,
L the length of the sample and
Wsₐᵢᵣ the weight of the sample measured in air.

The variation in the content by weight of fibers is assumed to be directly linked to a variation in the content of matrix without taking into account the variation in the amount of fibers in the reinforcement.

b) Determination of the Theoretical Density:

$$d \text{?} = \frac{1}{\frac{1 - \% {Wf}_{th}}{{d}_{m}} + \frac{\% {Wf}_{th}}{{d}_{f}}} \qquad [ Math 4 ]$$

$$\text{?} \text{indicates text missing or illegible when filed}$$

with dₘ and d_{f} the respective densities of the matrix and of the fibers.

The theoretical density thus calculated is the accessible density if there is no porosity in the samples.

c) Evaluation of the Porosity:

The porosity is then the relative deviation between theoretical density and experimental density.

1. A multilayer structure chosen from a tank, a pipe and a tube, configured for the transportation, for the distribution or for the storage of a gas, comprising, from the inside toward the outside,
N composite reinforcing layer(s) (2), deposited on one another, and consisting of a fibrous material in the form of continuous fibers which is impregnated by a composition comprising predominantly at least one semicrystalline thermoplastic polymer P1, the M.p. of which, as measured according to ISO 11357-3:2013, is greater than or equal to 150° C., or at least one amorphous thermoplastic polymer, the Tg of which is greater than 80° C.,
N being of from 1 to 2000 layers, and
an outer sealing layer (1) cohesive with the outermost composite reinforcing layer (2) and consisting of said composition comprising predominantly said at least one thermoplastic polymer P1, polypropylene being excluded from said semicrystalline thermoplastic polymer P1,
said composition of the outer sealing layer (1) resulting from at least the outermost composite reinforcing layer (2), said outer sealing layer (1) exhibiting a thickness of at least 5 μm, the sum of the thicknesses of each composite reinforcing layer (2) and of the thickness of the outer sealing layer (1) being equal to the sum of the thicknesses of said N layers before deposition, minus possible porosities.

2. The multilayer structure as claimed in claim 1, wherein each composite reinforcing layer (2) consists, before deposition, of said impregnated fibrous material in the form of continuous fibers exhibiting an initial content of fibers of from 45% to 65% by volume.

3. The multilayer structure as claimed in claim 1, wherein each composite reinforcing layer (2) consists, after deposition, of said impregnated fibrous material in the form of continuous fibers exhibiting a content of fibers of from 50% to 70% by volume.

4. The multilayer structure as claimed in claim 1, wherein the residual porosities, when they are present, of said composite reinforcing layers are decreased by at most 90%.

5. The multilayer structure as claimed in claim 1, wherein the total thickness, corresponding to the sum of the thicknesses of each composite reinforcing layer (2) after deposition and of the thickness of the outer sealing layer, is equal to N×the initial thickness (Thᵢ) of each composite reinforcing layer (2) before deposition, minus possible porosities.

6. The multilayer structure as claimed in claim 5, wherein the thickness of the sealing layer is of from:
5 μm to [(1−(T_{min before deposition}/T_{max after deposition}))×N×Thᵢ×(1−x %)]μm
in which:
T_{min before deposition} represents the minimum content of fibers by volume before deposition,
T_{max after deposition} represents the maximum content of fibers by volume in the reinforcing layer after deposition,
N represents the number of reinforcing layers, and
Thᵢ represents the initial thickness of the impregnated fibrous material before deposition,
x % the content of porosities in the initial tape before deposition.

7. The multilayer structure as claimed in claim 1, wherein said structure furthermore comprises at least one inner sealing layer (3), located under the innermost composite reinforcing layer (2), and consisting of a composition comprising predominantly at least one semicrystalline thermoplastic polymer P2 or made of composite material and consisting of fibers impregnated with a composition comprising predominantly at least one semicrystalline thermoplastic polymer P2, the M.p. of said semicrystalline thermoplastic polymer P2, as measured according to ISO 11357-3:2013, being less than 300° C., said innermost inner sealing layer (3) being in contact with the gas.

8. The multilayer structure as claimed in claim 7, wherein said innermost composite reinforcing layer (2) is welded to said adjacent outermost inner sealing layer (3).

9. The multilayer structure as claimed in claim 1, wherein said structure is devoid of an inner sealing layer (3) located under the innermost composite reinforcing layer (2), said innermost composite reinforcing layer (2) being in contact with the gas.

10. The multilayer structure as claimed in claim 1, wherein the number-average molecular weight Mn of said thermoplastic polymer P1 is of from 11,000 to 40,000 g/mol.

11. The multilayer structure as claimed in claim 1, wherein said gas is hydrogen and the total proportion of extracted contaminants in the hydrogen is less than or equal to 3% by weight, of the sum of the constituents of said composition impregnating said fibrous material or of the composition constituting said inner sealing layer (3), as determined by a test of contaminants present in the hydrogen and extracted from said composite reinforcing layer (2) or from said inner sealing layer (3) after contact of the hydrogen with this, said test being carried out as defined in the standard CSA/ANSI CHMC 2:19.

12. The multilayer structure as claimed in claim 1, wherein said structure is chosen from a cylindrical tank, a polymorphic tank, a bendable pipe and a bent pipe.

13. The multilayer structure as claimed in claim 1, wherein said at least one thermoplastic polymer P1 is a reactive polymer or a nonreactive polymer.

14. The multilayer structure as claimed in claim 1, wherein said at least one thermoplastic polymer P1 is selected from: polyaryl ether ketones (PAEKs); polyaryl ether ketone ketones (PAEKKs); aromatic polyetherimides (PEIs); polyaryl sulfones; polyaryl sulfides; polyamides (PAs); polyolefins, with the exclusion of polypropylene; polylactic acid (PLA); polyvinyl alcohol (PVA); fluoropolymers; and their mixtures.

15. The multilayer structure as claimed in claim 14, wherein said at least one thermoplastic polymer P1 is selected from polyamides, PEKK, PEI and a mixture of PEKK and of PEI.

16. The multilayer structure as claimed in claim 14, wherein said polyamide is chosen from aliphatic polyamides, cycloaliphatic polyamides and semiaromatic polyamides (polyphthalamides).

17. The multilayer structure as claimed in claim 16, wherein said aliphatic polyamide is chosen from polyamide 6 (PA6), polyamide 11 (PA11), polyamide 12 (PA12), polyamide 66 (PA66), polyamide 46 (PA46), polyamide 610 (PA610), polyamide 612 (PA612), polyamide 1010 (PA1010), polyamide 1012 (PA1012), polyamide 11/1010 (PA11/1010) and polyamide 12/1010 (PA12/1010), or a blend of these or a copolyamide of these, and block copolymers, and said semiaromatic polyamide is a semiaromatic polyamide, optionally modified by urea units, or a semiaromatic polyamide of formula X/Yar.

18. The multilayer structure as claimed in claim 1, wherein said fibrous material comprises continuous fibers selected from carbon fibers, glass fibers, silicon carbide fibers, basalt fibers, basalt-based fibers, silica fibers, natural fibers, or amorphous thermoplastic fibers with a glass transition temperature Tg greater than the Tg of said polymer or of said blend of polymers when the latter is amorphous or greater than the M.p. of said polymer or of said blend of polymers when the latter is semicrystalline, or semicrystalline thermoplastic fibers with a melting point M.p. greater than the Tg of said polymer or of said blend of polymers when the latter is amorphous or greater than the M.p. of said polymer or of said blend of polymers when the latter is semicrystalline, or a mixture of two or more of said fibers.

19. The multilayer structure as claimed in claim 1, wherein said structure furthermore comprises at least one outer layer (4), said layer being the outermost layer of said multilayer structure.

20. The multilayer structure as claimed in claim 1, wherein the fibrous material is chosen from glass fibers, carbon fibers, basalt fibers and basalt-based fibers.

21. A process for the manufacture of a multilayer structure as defined in claim 1, wherein the process comprises a stage of deposition of at least one band of fibrous material impregnated with a thermoplastic polymer on a support, in order to form a composite reinforcing layer N, by means of a main heating system chosen from:
a system (1) for preheating said impregnated band of fibrous material before deposition of said band on said support, and a system for heating said impregnated band of fibrous material on its inner face (2) at the point of contact of said band with said support,
in combination with at least one secondary heating system making it possible for the composite reinforcing layer (2) N−1 on which the layer N will be deposited to be at a temperature greater than the M.p. of said thermoplastic polymer at the moment of contact of said layer N with said layer N−1.

22. The process as claimed in claim 21, wherein the secondary heating is chosen from the following:
a system for heating said impregnated band of fibrous material on its outer face (3) at the point of contact of said band with said support,
a system (4) for postheating said impregnated band n of fibrous material after deposition of said band n on said support,
a system (5) for heating said support, and
a system (6) for preheating the impregnated band n−1 of fibrous material previously deposited before deposition of said band n of fibrous material, it being possible for said systems 4 and 6 to be combined.

23. The process as claimed in claim 22, wherein said at least one main and secondary heating system is chosen from a heat-transfer fluid, induction heating, direct current, a heating cartridge, a heating press roller, a light-emitting diode (LED), infrared (IR), a UV source, hot air and a laser, it being possible for said primary and secondary heating systems to be identical or different.

24. The multilayer structure as claimed in claim 1, wherein N is from 2 to 2000 layers.

25. The multilayer structure as claimed in claim 1, wherein the outer sealing layer (1) has a thickness of at least 10 μm.
